(19) United States
(12) Patent Application Publication
(10) Pub. No.: US 2024/0281723 A1
(43) Pub. Date: Aug. 22, 2024

(54) METHOD AND SYSTEM FOR TIME SERIES FORECASTING VIA ENSEMBLE MACHINE LEARNING

(71) Applicant: Verizon Patent and Licensing Inc., Basking Ridge, NJ (US)

(72) Inventors: Mohammed A. Kaleem, Telangana (IN); Pramod Jain, Telangana (IN); Rajender R. Nednur, ALPHARETTA, GA (US); Vamsi Krishna Palivela, Telangana (IN)

(73) Assignee: Verizon Patent and Licensing Inc., Basking Ridge, NJ (US)

(21) Appl. No.: 18/172,460

(22) Filed: Feb. 22, 2023

(51) Int. Cl. G06N 20/20

(52) U.S. Cl. CPC G06N 20/20

(57) ABSTRACT

The present teaching relates to ensemble model based time series forecasting. Characteristics of historic time series data from a resource provider are used to select base forecast models. An ensemble forecast model is generated from the base forecast models using a set of parameters determined based on costs associated with respective base forecast models. The ensemble forecast model is used to forecast a resource need for the resource provider and the resource usage data at the resource provider is collected and added to the historic time series data.

### BACKGROUND

Time series forecasting may be used for predicting various needs and actions, e.g., an upcoming need for a resource based on observed past time series data on the consumption of the resource. For example, a usage demand for a particular cell tower may be predicted using past time series data. Similarly, the level of energy utility consumption with respect to a cell tower may be predicted via time series forecasting. Resources predicted may then be allocated prior to the actual demand arrives to avoid potential problems.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for time series forecasting model ensemble and application thereof, in accordance with an embodiment of the present teaching;

FIG. 1B is a flowchart of an exemplary process of a framework for time series forecasting model ensemble and application thereof, in accordance with an embodiment of the present teaching;

FIG. 2A depicts an exemplary high level system diagram of an ensemble model generator, in accordance with an embodiment of the present teaching;

FIG. 2B is a flowchart of an exemplary process of an ensemble model generator, in accordance with an embodiment of the present teaching;

FIG. 2C illustrates an exemplary ensemble mechanism for integrating different time series forecasting models, in accordance with an embodiment of the present teaching;

FIG. 3A depicts an exemplary high level system diagram of a seasonality determiner, in accordance with an embodiment of the present teaching;

FIG. 3B is a flowchart of an exemplary process of a seasonality determiner, in accordance with an embodiment of the present teaching;

FIG. 4A shows exemplary time series data and smoothed and detrended processing results thereof, in accordance with an embodiment of the present teaching;

FIG. 4B shows an exemplary autocorrelation result obtained based on smoothed time series data, in accordance with an embodiment of the present teaching;

FIG. 4C shows exemplary autocorrelation result obtained based on detrended time series data, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching is directed to automatically integrating time series models to generate an ensemble model that is adaptive to application time series data as well as application of the ensemble time series forecasting model to predict resource needs. In the field of advanced data analytics and econometrics, different time series forecasting models and methods have been developed and applied to fit different tasks or time series data with different characteristics. There is no “one size fits all” time series forecast model that may be deployed in any situation. For instance, some models may be more suitable for data having a high degree of randomness such as white noise and some may work well on data with less noise. Some models may be more appropriate for tasks aiming at short term projections and some may be suitable for tasks directed to predicting long term measures. Although it is possible to select a suitable model each time according to a task in hand, determining that the selected model fits the nature of the data needs to be done by manual experimentation, which can be time consuming. In addition, the characteristics of time series data may change over time, which makes it even more difficult to adaptively selecting suitable models.

The present teaching discloses a model integration framework to automatically and adaptively integrate/ensemble different time series forecast models. An ensemble model so created may be adjusted over time on-the-fly by continuously collecting time series data with varying characteristics. With the adjustment to the ensemble model based on continuously collected time series data, the ensemble model adapts in accordance with the varying characteristics of the underlying time series data. Below, the present teaching is disclosed using an exemplary application for predicting resource needs. It is understood that such exemplary application is merely for illustration and is not to be construed as a limitation to the scope of the present teaching.

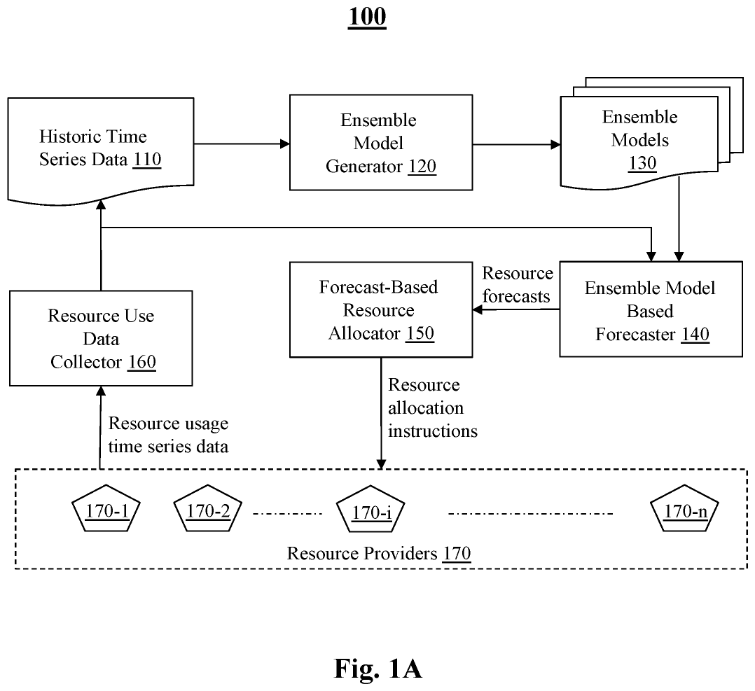

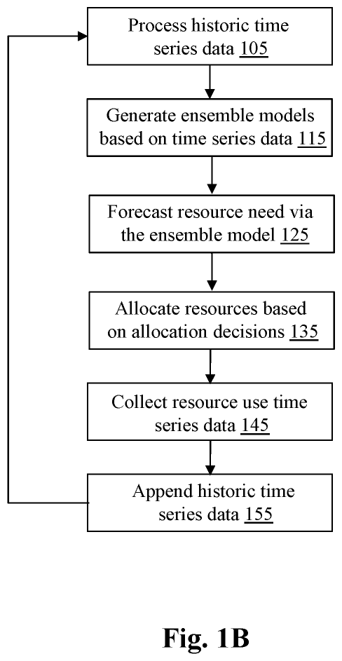

FIG. 1A depicts an exemplary framework 100 for time series forecasting model ensemble and application thereof, in accordance with an embodiment of the present teaching. In this embodiment, there are n resource providers 170-1, 170-2, . . . , 170-i, . . . , and 170-n. For example, a cell tower for a telecommunications provider for wireless communication may correspond to a resource provider, that provides the resources needed to satisfy the demand of wireless users of the telecommunications provider. In some applications, a resource provider may also correspond to a group of wired and wireless towers in a region that provides an adequate level of energy utility in accordance with a predicted level of energy utility consumption of users.

The resources needed by each of the resource providers 170 to support services may change over time. To facilitate smooth operation, the resource need for each resource provider may be predicted via time series forecasting based on data associated with the resource provider. The resource need as predicted with respect to each resource provider may then be used to allocate the predicted level of resource to each resource provider.

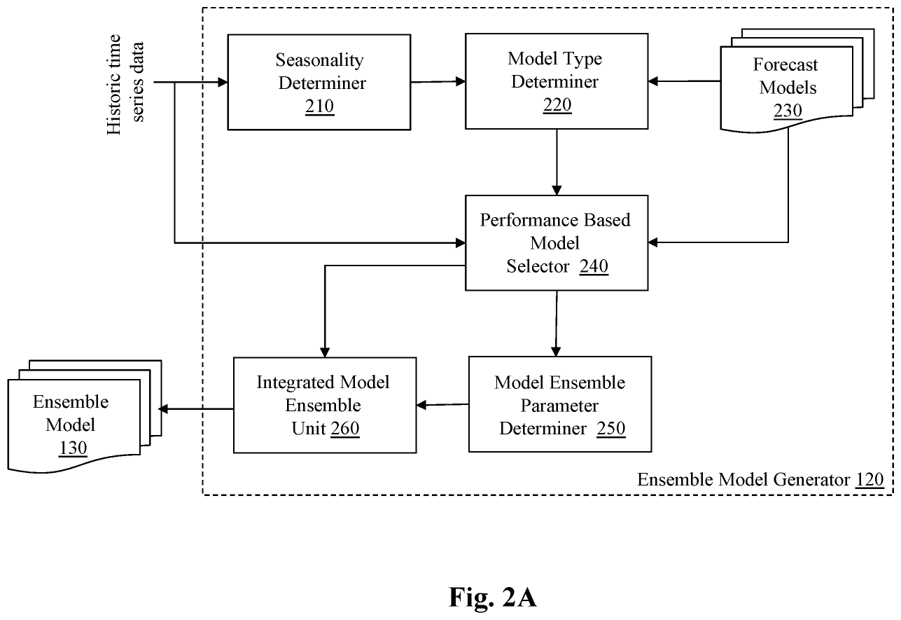

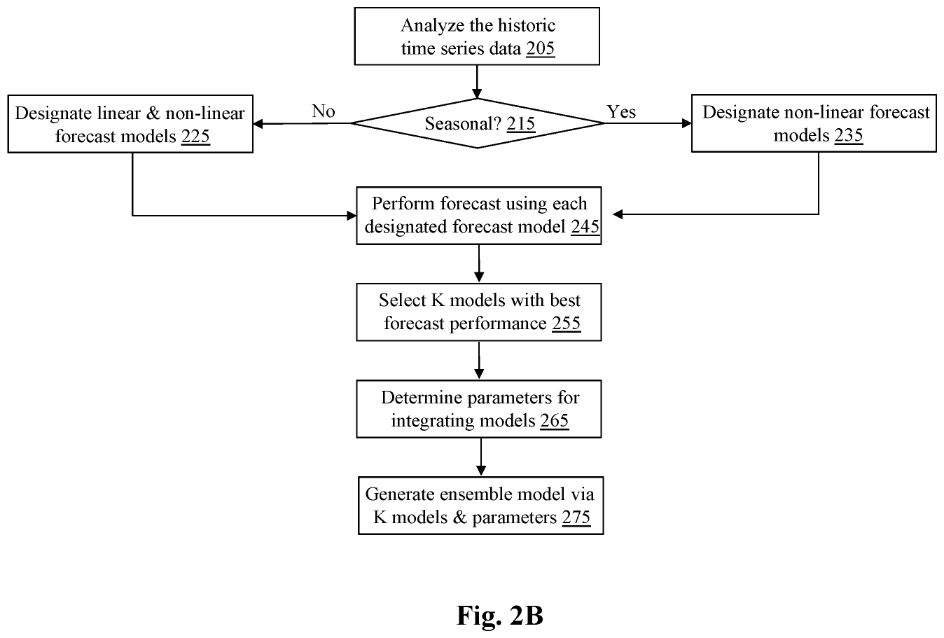

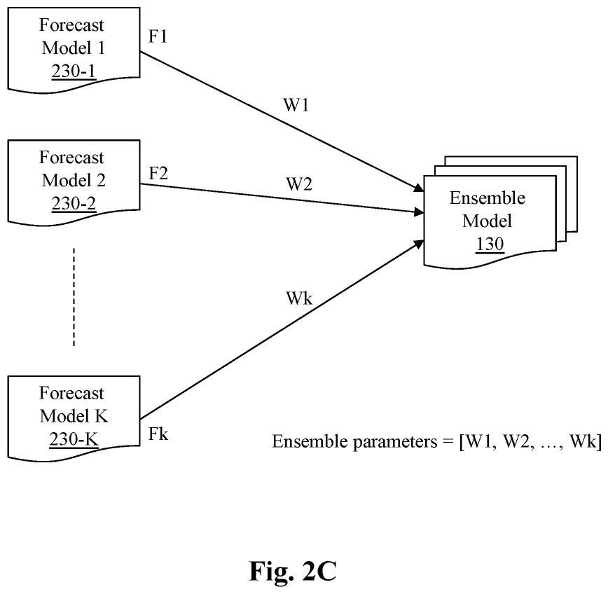

As discussed herein, over time, the resource need for each resource provider may vary. The actual resource usage data may continuously be collected as time series data and used for adapting the ensemble model. In such operations, the ensemble model generated according to the present teaching plays an important role to facilitate adaptive resource prediction and allocation. In this manner, ensemble model adaptation, adaptive prediction, and adaptive collection of time series data form a dynamic self-adaptation loop with respect to each resource provider. As shown in FIG. 1A, framework 100 comprises an ensemble model generator 120, an ensemble model based forecaster 140, a forecast-based resource allocator 150, and a resource use data collector 160. The ensemble model generator 120 generates an ensemble mode 130 with respect to each resource provider based on historic time series data 110 associated with the resource provider. Details regarding the ensemble model generator 120 are provided with reference to FIGS. 2A-4C.

With the ensemble models 130 for the respective resource providers 170 generated, the ensemble model based forecaster 140 predicts the resource need for each of the resource providers based on their respective ensemble models as well as their time series data recently collected. Such forecasts of resource needs (output from the ensemble model based forecaster 140) for respective resource providers may then be used by the forecast-based resource allocator 150 to allocate the predicted levels of resources to the resource providers 170.

To adapt the ensemble models 130, the resource use data collector 160 may continuously collect the actual resource usage time series data from the resource providers 170. Such newly collected data may then be used as a part of the historic time series data 110 which may be used by the ensemble model generator 120 to update the ensemble models 130. In some embodiments, the historic time series data 110 may be a data collection from a sliding time window of a certain appropriate length such as 12 months or 24 months. The data in the sliding window includes the newly collected time series data so that the historic time series data 110 corresponds to a rolling data set with the most recent and updated information for adapting the ensemble models 130. As discussed herein, based on the historic time series data 110, the ensemble model generator 120 may adjust the ensemble models 130 accordingly. The adjusted ensemble models 130 may then be used for forecasting future resource needs.

FIG. 1B is a flowchart of an exemplary process of framework 100 for time series forecasting model ensemble and application thereof, in accordance with an embodiment of the present teaching. Upon receiving the historic time series data 110, the ensemble model generator 120 processes the historic time series data at 105 and generates the ensemble models 130 at 115. As discussed herein, the historic time series data 110 includes time series information collected from different resource providers 170 so that each of the ensemble models 130 for a respective resource provider is generated according to the corresponding time series data associated with the resource provider. In some embodiments, each of the ensemble models with respect to a respective resource provider is used by the ensemble model based forecaster 140 to forecast, at 125, the resource needs of a corresponding resource provider. Such resource forecasts are then sent to the forecast-based resource allocator 150, which may allocate, at 135, resources to each of the resource providers according to the forecasted needs. The actual usage of resources from each resource provider may differ from the estimated level. To facilitate adaptation, the resource use data collector 160 collects, at 145, information about the actual resource usage with respect to different resource providers 170 and incorporates, at 155, such continuously collected time series data with the historic time series data 110.

FIG. 2A depicts an exemplary high level system diagram of the ensemble model generator 120, in accordance with an embodiment of the present teaching. As discussed herein, the present teaching discloses an approach to automatically integrate a group of base time series forecasting models to generate an ensemble forecast model for each resource provider according to the characteristics of the time series data collected therefrom. That is, the way to integrate the base time series forecast models for each resource provider is customized to fit the time series data associated therewith. In addition, as each ensemble forecast model is generated based on the continuously collected historic time series data 110 from an associated resource provider, the ensemble forecast model is adaptive to the changing situation.

In this illustrated embodiment, the ensemble model generator 120 comprises a seasonality determiner 210, a model type determiner 220, a performance based model selector 240, a model ensemble parameter determiner 250, and an integrated model ensemble unit 260. In operation, if the historic time series data 110 includes time series streams collected from different resource providers, the ensemble model generator 120 generates an ensemble model with respect to each resource provider. In some embodiments, the ensemble model generator 120 may correspond to a centralized operational mechanism responsible for creating an ensemble forecasting model for each resource provider. In some embodiments, the ensemble model generator 120 may correspond to a system of a plurality of distributed localized ensemble model generation units, each of which may be provided for generating ensemble models for one or more resource providers which may be local to the distributed localized ensemble model generation unit. The following disclosure about the ensemble model generator 120 may use an example of generation of an ensemble model for a resource provider, the present teaching may be applied to either a centralized or localized ensemble model generator to achieve the same for one or more resource providers.

During the operation, based on the time series data from a given resource provider, ensemble model generator 120 may analyze the characteristics of the time series data to facilitate automatic selection of suitable forecasting models that may fit the nature of the data. For example, some time series data may exhibit seasonality, some data may have excessive noise or particular types of noise (such as white noise). The characteristics or features derived from data analysis may impact the selection of appropriate forecast models to be used for ensemble. In addition, some forecast models may be more relevant to the time series data than others. The present teaching discloses an automatic approach to determine the relevance of each forecast model and accordingly optimize the selection of forecast models for ensemble based on their respective assessment. In some embodiments, the forecasting performance of each initially selected forecast model may be used to assess the relevance and the ones that are less relevant may be filtered out from the base forecast models for ensemble. Furthermore, to optimize the integration of selected base forecast models to generate an ensemble model, parameters used to combine the base forecast models may also be determined automatically. In some embodiments, the role of each base forecast model in the ensemble model may be determined in accordance with, e.g., their respective contributions so that the overall forecasting performance is optimized.

FIG. 2B is a flowchart of an exemplary process of the ensemble model generator 120, in accordance with an embodiment of the present teaching. In operation, when the historic time series data associated with a resource provider is received, the seasonality determiner 210 analyzes, at 205, the received data to capture the characteristics. Based on the analyzed characteristics of the input time series data, the model type determiner 220 determines, at 215, whether the time series data exhibits seasonality. In some embodiments, to facilitate the determination of seasonality, the data analysis may need to be based on time series data of some estimated window size, which may be application dependent. In one exemplary application for forecasting the customer usage demand of a cell tower of a communication service provider, the customer usage demand may be forecasted, which may include a forecast on how soon the existing available capacity will be exhausted and the level of capacity augmentation needed to keep the operation smooth. In this application, seasonality may be an important feature relevant to the forecast. For instance, the customer usage demand may be higher during different holidays, such as on the Independence Day, the Labor Day, Thanksgiving, Christmas, and New Year's Day. To detect such seasonality, the window size of the time series data used for analysis is essential and may be provided based on, e.g., 12 or 24 months, in order to observe and capture the seasonality.

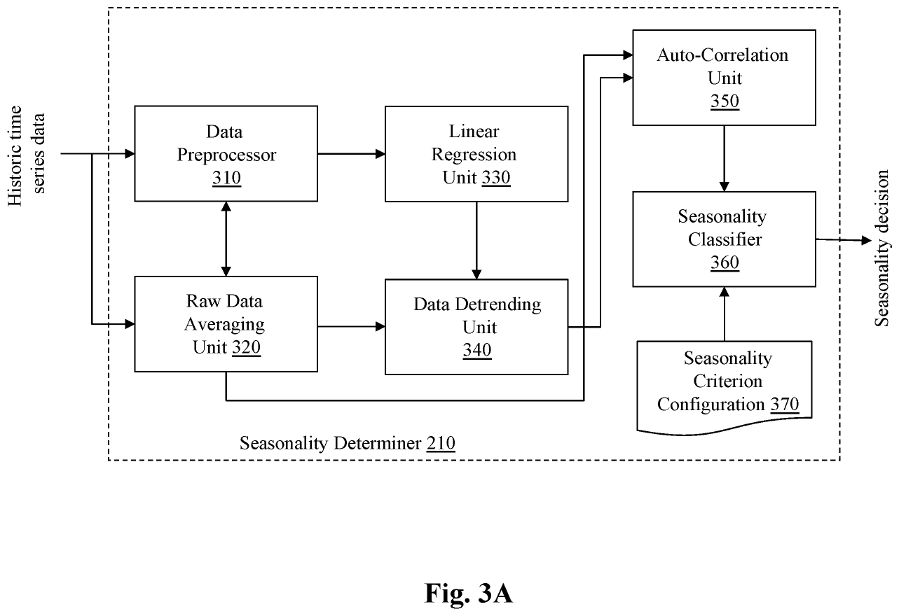

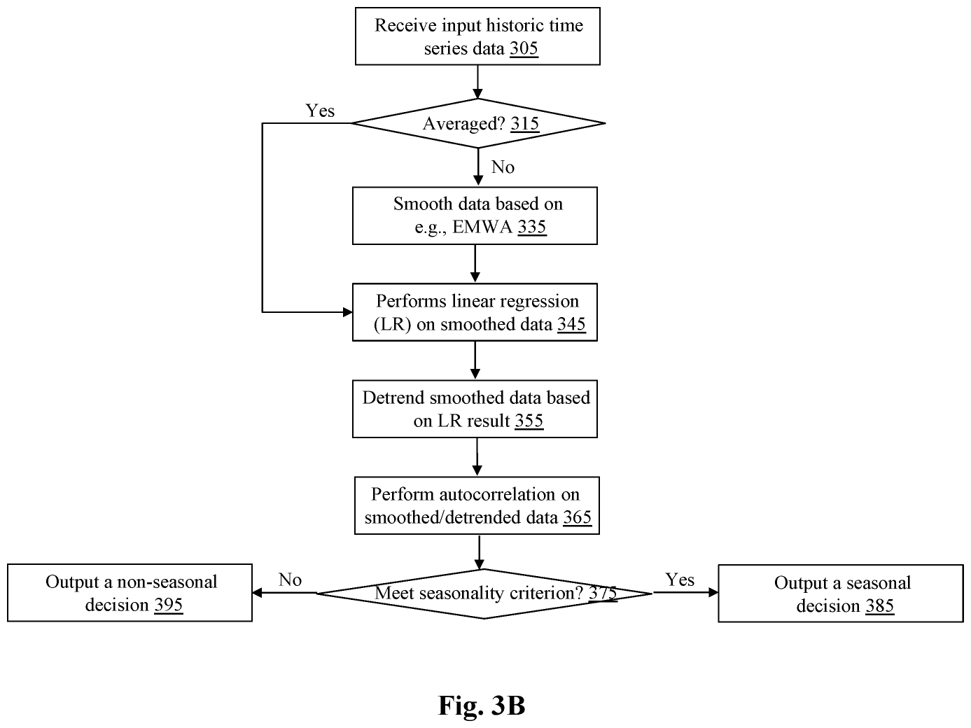

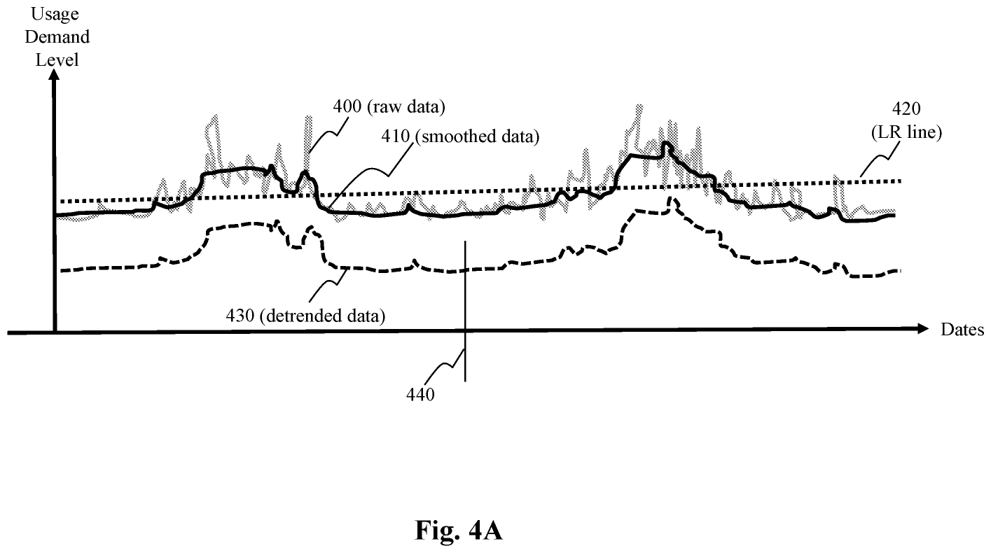

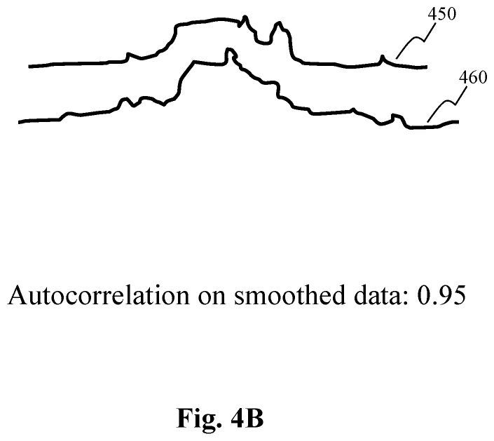

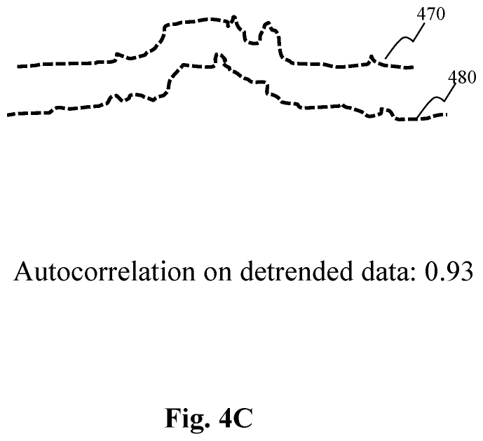

Depending on whether the analyzed time series data exhibits certain characteristics, different time series forecast models may be selected as candidate base forecast models. For instance, forecasting models developed for forecasting time series that exhibits seasonality may be appropriately utilized for modeling and predicting seasonal time series. Details on how to detect seasonality from input data according to some embodiments of the present teaching are provided with reference to FIGS. 3A-4C. If the received time series data exhibits seasonality, the model type determiner 220 may designate, at 235, some non-linear forecast models in the storage 230 as candidate base forecast models. That is, non-linear forecast models are considered suitable for time series data with seasonality. If the received time series data does not exhibit seasonality, the model type determiner 220 may designate, at 225, some linear and non-linear forecast models as candidate base forecast models. In this case, although seasonality is not exhibited in the time series data, some other non-linear properties may also exist. Both linear and non-linear models may be selected so that when combined, the ensemble model may be able to handle both linear and non-linear situations.

Based on, e.g., N, candidate base forecast models (designated based on observed characteristics of the input data), the performance based model selector 240 may generate a set of K base forecast models, where K<=N. In some embodiments, this may be achieved by filtering out some candidate models based on their forecasting performance. Specifically, each of the designated forecast models may be used to perform forecast at 245 and K models may be selected as base forecast models at 255 for ensemble. In some embodiments, each designated forecast model is used to perform a forecast based on some part of the received input time series data and then its performance may be assessed against another part of the input time series data. For example, given time series data of 24 months, the part of the time series data of the first 18 months may be used by a designated candidate forecast model for predicting the time series data of the remaining 6 moths. Then the predicted time series data may be compared with the received time series data for performance assessment. In some embodiments, a metric may be used to quantify the performance, such as a mean absolute percentage error (MAPE). Then the candidate forecast models may be ranked based on the metrics associated therewith. In some embodiments, it may be configured to select K top performing forecast models. In some embodiments, it may be configured that the performance of a candidate forecast model is to meet a certain criterion, e.g., MAPE<a threshold. In this case, the number K of selected base forecast models may change with respect to the time series data.

With the K selected base forecast models, the model ensemble parameter determiner 250 determines, at 265, parameters to be used in ensemble to combine these base models. In some embodiments, the base forecast models may be integrated via, e.g., a weighted sum of forecasted values from the base forecast models. FIG. 2C illustrates an exemplary ensemble mechanism for integrating different time series base forecast models, in accordance with an embodiment of the present teaching. In this example, there are K selected base forecast models 230-1. 230-2, . . . , 230-K, each of which may be used to predict a forecast value, e.g., corresponding to forecast values F1, F2, . . . , Fk, respectively. Such predicted forecast values from different base forecast models may then be combined as a weighted sum. For instance, the forecast value from base forecast model 230-1 may be associated with its weight W1, the forecast value from base forecast model 230-2 may be associated with its weight W2, . . . , and the forecast value from base forecast model 230-K may be associated with its weight Wk. The base forecast models 230-1-230-K are used to generate an ensemble model 130. Using the exemplary integration scheme disclosed herein, the ensemble model 130 may function to generate an integrated forecast value as:

$$G = Sum ( {W}_{i} \times {F}_{i} ) , 1 <= i <= K$$

where G is a function of the ensemble model 130. It is understood that this integration scheme is provided as an example for illustration and is not intended as a limitation to the scope of the present teaching. Any other integration scheme may be applied to generate the ensemble model 130.

In some embodiments, the weights illustrated herein, W1, W2, . . . , Wk, may also be automatically determined. In one illustrated example, a dynamic time warping (DTW) cost associated with each base forecast model may be used to compute the weight for the base forecast model. DTW corresponds to a family of algorithms for computing a local stretch or compression with respect to the time axis of two time series in order to map one (query) onto the other (reference). In another word, DTW measures the similarity between two temporal sequences, which may vary in speed. As such, a DTW algorithm outputs a cumulative distance between the two given time series, corresponding to a match between the two time series sequences. The calculation of DTW may observe certain restrictions and rules, e.g.,
Every index from the first sequence must be matched with one or more indices from the other sequence, and vice versa
The first index from the first sequence must be matched with the first index from the other sequence (but it does not have to be its only match)
The last index from the first sequence must be matched with the last index from the other sequence (but it does not have to be its only match)
The mapping of the indices from the first sequence to indices in the other sequence must be monotonically increasing, and vice versa.

An optimal match corresponds to a match that satisfies all the restrictions and the rules and that has the minimal cost, where the cost is computed as the sum of absolute differences between the values of each matched pair of indices In some embodiments, given the DTW cost computed for each of the base forecast models, the weight for the base forecast model may be computed using the following exemplary formulation:

$$Wi = 1 - ( D T W cost for model i / Total D T W cost for all base forecast models )$$

where 1<=i<=K and the total DTW cost for all base forecast models is the sum of the DTW costs associated with all base forecast models. With such parameters for ensemble determined at 265 (by the model ensemble parameter determiner 250), the integrated model ensemble unit 260 takes the selected base forecast models (from the performance based model selector 240) and the integration parameters (e.g., automatically determined weights from the model ensemble parameter determiner 250) and generates, at 275, the ensemble model 130.

As discussed herein, in selecting candidate base forecast models, seasonality is an important characteristic to be considered. In many applications, seasonality may often be observed. For example, the application to forecast customer usage demand at cell towers likely exhibit seasonality due to, e.g., repeated holidays yearly. Other applications may also have the same seasonality as a property observed from actual time series data. As such, detecting the presence of seasonality in data is important. FIG. 3A depicts an exemplary high level system diagram of the seasonality determiner 210, in accordance with an embodiment of the present teaching. In this illustrated embodiment, the seasonality determiner 210 comprises a data preprocessor 310, a raw data averaging unit 320, a linear regression unit 330, a data detrending unit 340, an auto-correlation unit 350, and a seasonality classifier 360.

To determine seasonality is to capture some repetitive patterns in the time series data. To do so, the window to be used for analyzing seasonality may be determined based on applications. For instance, using the example of forecasting customer usage demands at different cell towers, the data window may be selected as 24 months so that the seasonality arising from holidays may be observed. Different data processing may be applied to the historic time series data and the processed results may then be used for classification to detect seasonality. In some embodiments, auto-correlation or auto-regression may be applied to identify any repetitive patterns. To improve reliability of the detection, auto-correlation may be applied to different processed data. In this illustrated embodiment, based on received historic time series data, a window of a certain length of time (e.g., 24 months) may be applied for processing. Smoothing processing may be used to smooth the raw data to minimize the negative impact of, e.g., noise, etc. In some embodiments, the exponential weighted moving average (EWMA) method may be used for smoothing to produce smooth data.

To further maximize the revelation of repetitive pattern, detrending processing may also be performed. In some embodiments, to remove trend, linear regression (LR) may be performed on the smoothed data and then the linear regression result may then be subtracted from the smoothed data to generate detrended data. To detect any repeating pattern (seasonality), auto-correlation may be applied to both the smoothed data and the detrended data and the auto-correlation results may then be used to assess whether seasonality is present in the time series data or not. FIG. 3B is a flowchart of an exemplary process of the seasonality determiner 210, in accordance with an embodiment of the present teaching. The data preprocessor 310 receives, at 305, the input historic time series data. This is illustrated in FIG. 4A using the example application of customer usage demand with respect to a cell tower. In FIG. 4A, the X axis represents dates (time axis) and the Y axis represents the usage demand level. Plot 400 represents the raw historic time series data. If the received data is not averaged raw data, determined at 315, the raw data averaging unit 320 is invoked to smooth the input data at 335 based on, e.g., EMWA algorithm. Plot 410 in FIG. 4A represents the exemplary smoothed data.

Based on the smoothed data, the linear regression unit 330 performs, at 345, LR operation on the smoothed data to compute the LR line 420, as illustrated in FIG. 4A. To remove trend, the data detrending unit 340 detrends the smoothed data at 355 by subtracting the LR data (on 420) from smooth data (on 410), that yields the detrended data 430 in FIG. 4A. To detect repeating patterns, the auto-correlation unit 350 performs auto-correlation at 365 on both the smoothed data 410 and the detrended data 430. FIG. 4B illustrates an exemplary auto-correlation result based on smoothed data 410, where curve 450 corresponds to a portion of the smoothed data 410 prior to a fold point 440 (in FIG. 4A) and curve 460 corresponds to another portion of the smoothed data 410 after the fold point 440. As illustrated, the auto-correlation result on smoothed data is 0.95. FIG. 4C illustrates an exemplary auto-correlation result based on detrended data 430, where dotted curve 470 in FIG. 4C corresponds to a portion of the detrended data 430 prior to a fold point 440 and dotted curve 480 corresponds to the remaining portion of the detrended data 430 after the fold point 440. As shown, the exemplary auto-correlation result on detrended data is 0.93.

The auto-correlation results are then used by the seasonality classifier 360 to determine, at 375, whether seasonality is detected. If seasonality is detected, the seasonality classifier 360 outputs a seasonal decision at 385. If seasonality is not detected, the seasonality classifier 360 outputs a non-seasonal decision at 395. As depicted in FIG. 3A, seasonality classification may be performed based on some pre-configured seasonality criterion stored in 370. Such pre-configured criterion may be determined based on application needs or known properties of the time series data. For example, the seasonality criterion may be configured as both auto-correlation results are higher than 0.9 (90%). A different configuration may also be possible. For instance, in some situations, the LR result may have a large slope so that the auto-correlation result based on the detrended data may be significantly lower than that from the smoothed data. This may be so even when the auto-correlation result based on smoothed data indicates a strong auto-correlation. To avoid the possible unexpected impact of detrending, the seasonality criterion may be configured to compensate that. For instance, the seasonality criterion may be defined as that the auto-correlation of the smoothed data is above 0.95 (95%) and the auto-correlation of the detrended data is not lower than 0.8 (80%). Other criteria may also be adopted and may be determined based on specific situations encountered in the applications.

In an application, the base forecast models used to generate the ensemble model 130 may be a mixture of different types of models, each of which may be provided or suitable for data with certain characteristics. As discussed herein, as the ensemble model 130 is generated in an adaptive manner, both the mixture of base forecast models and the parameters used to integrate the base forecast models can be dynamically adjusted to optimize the forecast performance.

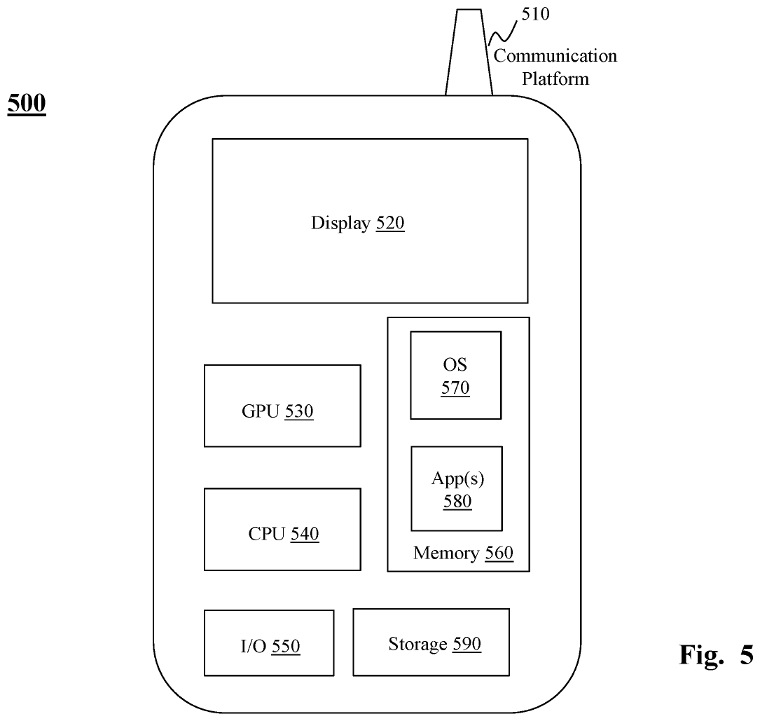

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or a mobile computational unit in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.) and one or more applications 580 may be loaded into memory 560 from storage 590 in order to be executed by the CPU 540. The applications 580 may include a user interface or any other suitable mobile apps for information exchange, analytics, and management according to the present teaching on, at least partially, the mobile device 500. User interactions, if any, may be achieved via the I/O devices 550 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

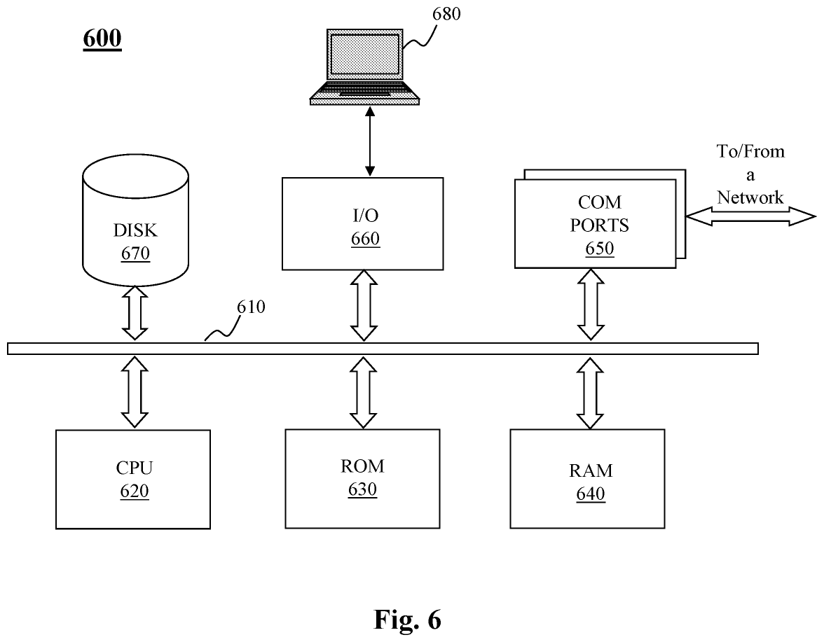

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information processing and analytical method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
determining characteristics of historic time series data associated with a resource provider;
selecting a plurality of base forecast models from available forecast models based on the characteristics of the historic time series data;
generating an ensemble forecast model based on the selected plurality of base forecast models by
computing a cost associated with each of the plurality of base forecast models,
determining a set of parameters to be used for generating the ensemble forecast models based on the costs associated respectively with the plurality of base forecast models, and
creating the ensemble forecast model based on the plurality of base forecast models in accordance with the set of parameters;
forecasting a resource need associated with the resource provider using the ensemble model, wherein the forecasted resource need is for allocating a resource to the resource provider;
collecting resource usage data associated with the resource provider; and
adding the resource usage data to the historic time series data.

2. The method of claim 1, wherein the characteristics of the historic time series data include seasonality or lack thereof exhibited in the historic time series data.

3. The method of claim 2, wherein the selecting a plurality of base forecast models comprises:
determining whether the historic time series data exhibits seasonality;
designating multiple candidate base forecast models from the available forecast models based on whether the historic time series data exhibits seasonality; and
identifying the plurality of base forecast models from the multiple candidate base forecast models based on forecast performance of each of the multiple candidate base forecast models.

4. The method of claim 3, wherein the determining whether the historic time series data exhibits seasonality comprises:
performing linear regression on smoothed historic time series data to generate linear regression result;
generating detrended historic time series data based on the smoothed historic time series data and the linear regression result;
performing auto-correlation on the smoothed time series data and the detrended historic time series data to generate auto-correlation results; and
determining whether the historic time series data exhibits seasonality based on the auto-correlation results.

5. The method of claim 4, wherein the auto-correlation results include:
a first auto-correlation metric obtained via auto-correlation on the smoothed historic time series data; and
a second auto-correlation metric obtained via auto-correlation on the detrended historic time series data.

6. The method of claim 3, wherein the identifying the plurality of base forecast models comprises:
with respect to each of the multiple candidate base forecast models,
generating a forecast result based on the historic time series data using the candidate base forecast model,
computing a measure indicative of the performance of the candidate base forecast model based on the forecast result; and
selecting the plurality of base forecast models from the multiple candidate base forecast models based on the measures associated respectively with the multiple candidate base forecast models.

7. The method of claim 1, wherein the ensemble forecast model corresponds to a weighted sum of the plurality of base forecast models, wherein the set of parameters correspond to weights to be applied to the respective base forecast models.

8. A machine readable and non-transitory medium having information recorded thereon, wherein the information, when read by the machine, causes the machine to perform the following steps:
determining characteristics of historic time series data associated with a resource provider;
selecting a plurality of base forecast models from available forecast models based on the characteristics of the historic time series data;
generating an ensemble forecast model based on the selected plurality of base forecast models by
computing a cost associated with each of the plurality of base forecast models,
determining a set of parameters to be used for generating the ensemble forecast models based on the costs associated respectively with the plurality of base forecast models, and
creating the ensemble forecast model based on the plurality of base forecast models in accordance with the set of parameters;
forecasting a resource need associated with the resource provider using the ensemble model, wherein the forecasted resource need is for allocating a resource to the resource provider;
collecting resource usage data associated with the resource provider; and
adding the resource usage data to the historic time series data.

9. The medium of claim 8, wherein the characteristics of the historic time series data include seasonality or lack thereof exhibited in the historic time series data.

10. The medium of claim 9, wherein the selecting a plurality of base forecast models comprises:
determining whether the historic time series data exhibits seasonality;
designating multiple candidate base forecast models from the available forecast models based on whether the historic time series data exhibits seasonality; and
identifying the plurality of base forecast models from the multiple candidate base forecast models based on forecast performance of each of the multiple candidate base forecast models.

11. The medium of claim 10, wherein the determining whether the historic time series data exhibits seasonality comprises:
performing linear regression on smoothed historic time series data to generate linear regression result;
generating detrended historic time series data based on the smoothed historic time series data and the linear regression result;
performing auto-correlation on the smoothed time series data and the detrended historic time series data to generate auto-correlation results; and
determining whether the historic time series data exhibits seasonality based on the auto-correlation results.

12. The medium of claim 11, wherein the auto-correlation results include:
a first auto-correlation metric obtained via auto-correlation on the smoothed historic time series data; and
a second auto-correlation metric obtained via auto-correlation on the detrended historic time series data.

13. The medium of claim 10, wherein the identifying the plurality of base forecast models comprises:
with respect to each of the multiple candidate base forecast models,
generating a forecast result based on the historic time series data using the candidate base forecast model,
computing a measure indicative of the performance of the candidate base forecast model based on the forecast result; and
selecting the plurality of base forecast models from the multiple candidate base forecast models based on the measures associated respectively with the multiple candidate base forecast models.

14. The medium of claim 8, wherein the ensemble forecast model corresponds to a weighted sum of the plurality of base forecast models, wherein the set of parameters correspond to weights to be applied to the respective base forecast models.

15. A system, comprising:
a data preprocessor implemented by a processor and configured for determining characteristics of historic time series data associated with a resource provider;
a performance based model selector implemented by a processor and configured for selecting a plurality of base forecast models from available forecast models based on the characteristics of the historic time series data;
an integrated model ensemble unit implemented by a processor and configured for generating an ensemble forecast model based on the selected plurality of base forecast models by
computing a cost associated with each of the plurality of base forecast models,
determining a set of parameters to be used for generating the ensemble forecast models based on the costs associated respectively with the plurality of base forecast models, and
creating the ensemble forecast model based on the plurality of base forecast models in accordance with the set of parameters;
an ensemble model based forecaster implemented by a processor and configured for forecasting a resource need associated with the resource provider using the ensemble model, wherein the forecasted resource need is for allocating a resource to the resource provider; and
a resource use data collectors implemented by a processor and configured for
collecting resource usage data associated with the resource provider, and
adding the resource usage data to the historic time series data.

16. The system of claim 15, wherein the selecting a plurality of base forecast models comprises:
determining whether the historic time series data exhibits seasonality;
designating multiple candidate base forecast models from the available forecast models based on whether the historic time series data exhibits seasonality; and
identifying the plurality of base forecast models from the multiple candidate base forecast models based on forecast performance of each of the multiple candidate base forecast models.

17. The system of claim 16, wherein the determining whether the historic time series data exhibits seasonality comprises:
performing linear regression on smoothed historic time series data to generate linear regression result;
generating detrended historic time series data based on the smoothed historic time series data and the linear regression result;
performing auto-correlation on the smoothed time series data and the detrended historic time series data to generate auto-correlation results; and
determining whether the historic time series data exhibits seasonality based on the auto-correlation results.

18. The system of claim 17, wherein the auto-correlation results include:
a first auto-correlation metric obtained via auto-correlation on the smoothed historic time series data; and
a second auto-correlation metric obtained via auto-correlation on the detrended historic time series data.

19. The system of claim 16, wherein the identifying the plurality of base forecast models comprises:
with respect to each of the multiple candidate base forecast models,
generating a forecast result based on the historic time series data using the candidate base forecast model,
computing a measure indicative of the performance of the candidate base forecast model based on the forecast result; and
selecting the plurality of base forecast models from the multiple candidate base forecast models based on the measures associated respectively with the multiple candidate base forecast models.

20. The system of claim 15, wherein the ensemble forecast model corresponds to a weighted sum of the plurality of base forecast models, wherein the set of parameters correspond to weights to be applied to the respective base forecast models.
